(19) United States
(12) Patent Application Publication
(10) Pub. No.: US 2015/0175157 A1
(43) Pub. Date: Jun. 25, 2015

(54) HYBRID VEHICLE

(71) Applicant: Toyota Jidosha Kabushiki Kaisha, Toyota-shi Aichi-ken (JP)

(72) Inventors: Ryuta Teraya, Susono-shi Shizuoka-ken (JP); Toshikazu Kato, Toyota-shi Aichi-ken (JP); Yoshikazu Asami, Susono-shi Shizuoka-ken (JP)

(21) Appl. No.: 14/573,360

(22) Filed: Dec. 17, 2014

(30) Foreign Application Priority Data
Dec. 19, 2013 (JP) 2013-262675

(51) Int. Cl. B60W 20/00; F01L 13/00; F02N 11/08; F01L 1/34

(52) U.S. Cl. CPC B60W 20/50; F01L 1/34; F01L 13/0015; B60W 20/40; F02N 11/0829

(57) ABSTRACT

An engine has a variable valve actuation device for varying an actuation characteristic of an intake valve. The variable valve actuation device controls an amount of lifting the intake valve and/or a working angle on the intake valve, and when the actuation characteristic is fixed with the amount and/or the angle smaller than a prescribed value, intermittently operating the engine is not unconditionally stopped, and when the vehicle is not in such a state that the engine would be started with a shock significantly annoying the user, or a state inviting aggravated engine start shock, intermittently stopping the engine is permitted.

This nonprovisional application is based on Japanese Patent Application No. 2013-262675 filed on Dec. 19, 2013, with the Japan Patent Office, the entire contents of which are hereby incorporated by reference.

### BACKGROUND OF THE INVENTION

1. Field of the Invention

The present invention relates to a hybrid vehicle, and more specifically to a hybrid vehicle including an internal combustion engine having a variable valve actuation device for varying an actuation characteristic of an intake valve.

2. Description of the Background Art

An internal combustion engine is known to have a variable valve actuation device capable of varying an actuation characteristic of an intake valve. Furthermore, one such variable valve actuation device is known to allow an intake valve to be lifted in a varying amount and/or worked by a varying working angle.

For example, Japanese Patent Laying-Open No. 2009-202662 discloses a hybrid vehicle having mounted therein an internal combustion engine having a variable valve actuation device allowing an intake valve to be lifted in an amount varying in magnitude and to be worked by a working angle (or an operation angle) varying in magnitude. Japanese Patent Laying-Open No. 2009-202662 discloses that when the hybrid vehicle has the variable valve actuation device diagnosed to have failed, and the vehicle is also travelling and stopped, the internal combustion engine is prohibited from stopping.

### SUMMARY OF THE INVENTION

Generally, a hybrid vehicle allows vehicular speed, a required driving force requested by the driver (or an amount by which the accelerator is operated), and other vehicular conditions to be considered to allow the internal combustion engine to be operated and stopped as automatically controlled, i.e., to be intermittently operated, for better fuel economy.

If stopping the internal combustion engine is prohibited whenever the variable valve actuation device has failed or the like and the intake valve accordingly has an actuation characteristic fixed (i.e., is lifted in a fixed amount and/or worked by a fixed working angle), as described in Japanese Patent Laying-Open No. 2009-202662, however, the internal combustion engine is prevented from intermittently stopping, which may result in impaired fuel economy. On the one hand, if the internal combustion engine is allowed to stop intermittently in view of fuel economy, and the intake valve has some actuation characteristic fixed, the internal combustion engine may be restarted with vibration giving discomfort to or annoying the user.

The present invention has been made to address such an issue, and an object of the present invention is to allow an internal combustion engine to be started with the user experiencing less discomfort and in addition achieve better fuel economy while at least one of an amount of lifting an intake valve and a working angle on the intake valve that are controlled by a variable valve actuation device is fixed.

The present invention in one aspect provides a hybrid vehicle comprising: an internal combustion engine having a variable valve actuation device configured to vary an actuation characteristic of an intake valve, the actuation characteristic being an amount of lifting the intake valve and/or a working angle on the intake valve; a detector; a rotating electric machine configured to be capable of starting the internal combustion engine; a power storage device configured to store electric power therein for driving the rotating electric machine; and a control device configured to receive an output of the detector and also control the internal combustion engine. The detector is configured to detect the actuation characteristic controlled by the variable valve actuation device. The control device permits intermittently stopping the internal combustion engine, in a case where the detector detects that the actuation characteristic is fixed to be smaller than a prescribed value, when at least one of first to fourth conditions has also been established, the first condition being that the power storage device has an upper limit value for electric power charged having an absolute value larger than a first prescribed electric power value, the second condition being that the power storage device has an upper limit value for electric power discharged having an absolute value larger than a second prescribed electric power value, the third condition being that the power storage device is higher in temperature than a first prescribed temperature, the fourth condition being that the vehicle has a vehicular speed faster than a prescribed speed.

When the present hybrid vehicle has the variable valve actuation device having failed or is at a low temperature and thus has increased friction or the like, and accordingly the actuation characteristic is fixed such that at least one of an amount of lifting the intake valve and a working angle on the intake valve, which are controlled by the variable valve actuation device, is fixed to be smaller than a prescribed value, intermittently stopping the internal combustion engine is not unconditionally prohibited and is instead permitted in accordance with the power storage device's conditions allowing the rotating electric machine to ensure a motoring torque (i.e., the first to third conditions) and a condition for non low vehicular speed (i.e., the fourth condition). When the intake valve is lifted in a small amount and/or worked by a small working angle, the internal combustion engine is started with an increased compression ratio and hence increased vibration. Allowing the rotating electric machine to ensure the motoring torque to allow the internal combustion engine to be started with a rotational speed passing through an engine speed range (a resonant frequency range) that facilitates exciting vibration in a short period of time allows the engine to be started with reduced vibration. Furthermore, as vehicular speed increases, the internal combustion engine can be started with vibration less perceivable by the user. Accordingly, with reference to the first to fourth conditions, when the internal combustion engine can be started without vibration giving substantial discomfort to the user, intermittently stopping the internal combustion engine is permitted, and the internal combustion engine can thus be started with the user experiencing less discomfort, and in addition, better fuel economy can be achieved than when intermittently stopping the internal combustion engine is unconditionally prohibited.

Preferably, the control device permits intermittently stopping the internal combustion engine, in the case where the actuation characteristic is fixed with the amount and/or the angle smaller than the prescribed value, when at least any one of the first to fourth conditions, a fifth condition, and a sixth condition has also been established, the fifth condition being that the internal combustion engine has a water coolant higher in temperature than a second prescribed temperature, the sixth condition being that the internal combustion engine has a lubricant oil higher in temperature than a third prescribed temperature.

When the internal combustion engine is in a warm state, the internal combustion engine has reduced friction and provides steady combustion and accordingly, can be started with reduced vibration. Accordingly, intermittently stopping the internal combustion engine is permitted even when the amount of lifting the intake valve and/or the working angle on the intake valve that are controlled by the variable valve actuation device is fixed to be smaller than a prescribed value. This allows the internal combustion engine to be started with the user experiencing less discomfort and also ensures an opportunity to provide an intermittent operation to achieve further better fuel economy.

Still preferably, the control device permits intermittently stopping the internal combustion engine, in a case where the actuation characteristic is fixed with the amount and/or the angle larger than the prescribed value.

Intermittently stopping the internal combustion engine is permitted when the internal combustion engine can be started with a reduced compression ratio and in that condition the actuation characteristic (the amount of lifting the intake valve and/or the working angle on the intake valve) controlled by the variable valve actuation device is also fixed. This allows the internal combustion engine to be started with the user experiencing less discomfort and also ensures an opportunity to provide an intermittent operation to achieve further better fuel economy.

Preferably, the control device prohibits intermittently stopping the internal combustion engine, in the case where the actuation characteristic is fixed with the amount and/or the angle smaller than the prescribed value, when none of the first to fourth conditions or none of the first to sixth conditions has been established.

When the actuation characteristic of the intake valve (the amount of lifting the intake valve and/or the working angle on the intake valve) controlled by the variable valve actuation device is fixed to be smaller than a prescribed value, and starting the internal combustion engine easily provides vibration giving discomfort to the user, intermittently stopping the internal combustion engine is prohibited to allow the internal combustion engine to be started with the user experiencing less discomfort.

Still preferably, the variable valve actuation device is configured to be capable of switching the actuation characteristic of the intake valve to any one of a first characteristic, a second characteristic allowing the amount and/or the angle to be larger than when the actuation characteristic is the first characteristic, and a third characteristic allowing the amount and/or the angle to be larger than when the actuation characteristic is the second characteristic, for a total of three levels. The control device permits intermittently stopping the internal combustion engine, in a case where the intake valve has the actuation characteristic fixed in accordance with the first characteristic, when at least any one of the first to fourth conditions has also been established. Still preferably, the control device permits intermittently stopping the internal combustion engine, in a case where the actuation characteristic is fixed in accordance with one of the second and third characteristics.

When the intake valve having an actuation characteristic (or lifted in an amount and/or worked by a working angle) controlled in three levels by a variable valve actuation device has the amount and/or the angle, which are controlled by the variable valve actuation device, fixed in the variable valve actuation device to be smaller than a prescribed value, intermittently stopping the internal combustion engine is permitted to allow the internal combustion engine to be started with the user experiencing less discomfort, and in addition, achieve better fuel economy. This allows the variable valve actuation device to be simply configured and the internal combustion engine to be controlled via a parameter adapted in a reduced period of time. Furthermore, the internal combustion engine can be controlled more precisely than when the intake valve has the actuation characteristic limited to two levels as described hereinafter.

Alternatively, preferably, the variable valve actuation device is configured to be capable of switching the actuation characteristic of the intake valve to any one of a first characteristic and a second characteristic allowing the amount and/or the angle to be larger than when the actuation characteristic is the first characteristic, for a total of two levels. The control device permits intermittently stopping the internal combustion engine, in the case where the intake valve has the actuation characteristic fixed to the first characteristic, when at least any one of the first to fourth conditions has also been established. Still preferably, the control device permits intermittently stopping the internal combustion engine, in a case where the actuation characteristic is fixed in accordance with the second characteristic.

When the intake valve having an actuation characteristic (or lifted in an amount and/or worked by a working angle) limited to two levels by a variable valve actuation device has the actuation characteristic fixed in the variable valve actuation device with the amount and/or the angle, which are controlled by the variable valve actuation device, smaller than a prescribed value, intermittently stopping the internal combustion engine is permitted to allow the internal combustion engine to be started with the user experiencing less discomfort, and in addition, achieve better fuel economy. This allows the variable valve actuation device to be simply configured and the internal combustion engine to be controlled via a parameter adapted in a reduced period of time.

Still preferably, when the intake valve has the actuation characteristic configured to be switchable in two or three levels, the control device permits intermittently stopping the internal combustion engine, in the case where the intake valve has the actuation characteristic fixed in accordance with the first characteristic, when at least any one of the first to fourth conditions, a fifth condition, and a sixth condition has also been established, the fifth condition being that the internal combustion engine has a water coolant higher in temperature than a second prescribed temperature, the sixth condition being that the internal combustion engine has a lubricant oil higher in temperature than a third prescribed temperature.

When the intake valve has an actuation characteristic (or is lifted in an amount and/or worked by a working angle) limited to two levels by a variable valve actuation device and the internal combustion engine is in a warm state allowing the internal combustion engine to be started with limited vibration, and in that condition the intake valve has the actuation characteristic fixed in accordance with a first characteristic causing the variable valve actuation device to control the intake valve to be lifted in a small amount and/or worked by a small working angle, intermittently stopping the internal combustion engine is nonetheless permitted, and better fuel economy can be achieved.

Furthermore, preferably, when the intake valve has the actuation characteristic configured to be switchable in two or three levels, the control device prohibits intermittently stopping the internal combustion engine, in the case where the intake valve has the actuation characteristic fixed in accordance with the first characteristic, when none of the first to fourth conditions or none of the first to sixth conditions has been established.

When the intake valve having an actuation characteristic (or lifted in an amount and/or worked by a working angle) limited to two levels by a variable valve actuation device has the actuation characteristic fixed in the variable valve actuation device in accordance with a first characteristic providing the amount and/or the angle to be small, and starting the internal combustion engine also easily provides vibration giving discomfort to the user, intermittently stopping the internal combustion engine is prohibited to allow the internal combustion engine to be started with the user experiencing less discomfort.

Preferably, the rotating electric machine is mechanically coupled with both an output shaft of the internal combustion engine and a drive shaft of the hybrid vehicle at least via a motive power transmission gear.

A rotating electric machine that is also applicable to causing the vehicle to travel is used to output a cranking torque to start the internal combustion engine, and the internal combustion engine can be started with the user experiencing less discomfort and in addition further better fuel economy can also be achieved.

A major advantage of the present invention lies in that when an internal combustion engine has an intake valve lifted in an amount and/or worked by a working angle, as controlled by a variable valve actuation device, and the amount and/or the angle are/is fixed, the internal combustion engine can nonetheless be started with the user experiencing less discomfort, and in addition, achieve better fuel economy.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram generally showing a configuration of a hybrid vehicle according to a first embodiment of the present invention.

FIG. 2 is a transition diagram for illustrating how an intermittent engine operation is controlled in the hybrid vehicle shown in FIG. 1.

FIG. 3 shows a configuration of an engine shown in FIG. 1.

FIG. 4 represents a relationship, as implemented in a VVL device, between a valve's displacement in amount and crank angle.

FIG. 5 is a front view of the VVL device.

FIG. 6 is a partial perspective view of the VVL device shown in FIG. 5.

FIG. 7 provides a representation for illustrating an operation provided when an intake valve is lifted in a large amount and worked by a large working angle.

FIG. 8 provides a representation for illustrating an operation provided when the intake valve is lifted in a small amount and worked by a small working angle.

FIG. 9 provides a first representation for representing a characteristic in performance of a power storage device.

FIG. 10 provides a second representation for representing a characteristic in performance of the power storage device.

FIG. 11 is a flowchart of a process for controlling an intermittent engine operation in a hybrid vehicle according to an embodiment of the present invention.

FIG. 12 is a table for describing conditions for determining whether engine start shock is aggravated.

FIG. 13 represents a relationship between the intake valve's displacement in amount and crank angle, as implemented in a VVL device that can vary the intake valve's actuation characteristic in three levels.

FIG. 14 shows an operating line of an engine including a VVL device having the actuation characteristic shown in FIG. 13.

FIG. 15 is a flowchart of a process for controlling an intermittent engine operation according to an embodiment of the present invention having applied thereto a VVL device having the FIG. 13 actuation characteristic.

FIG. 16 represents a relationship between the intake valve's displacement in amount and crank angle, as implemented in a VVL device that can vary the intake valve's actuation characteristic in two levels.

### DESCRIPTION OF THE PREFERRED EMBODIMENTS

Hereinafter reference will be made to the drawings to describe the present invention in embodiments. Hereinafter, a plurality of embodiments will be described. In the figures, identical or corresponding components are identically denoted, and will not be described repeatedly.

### First Embodiment

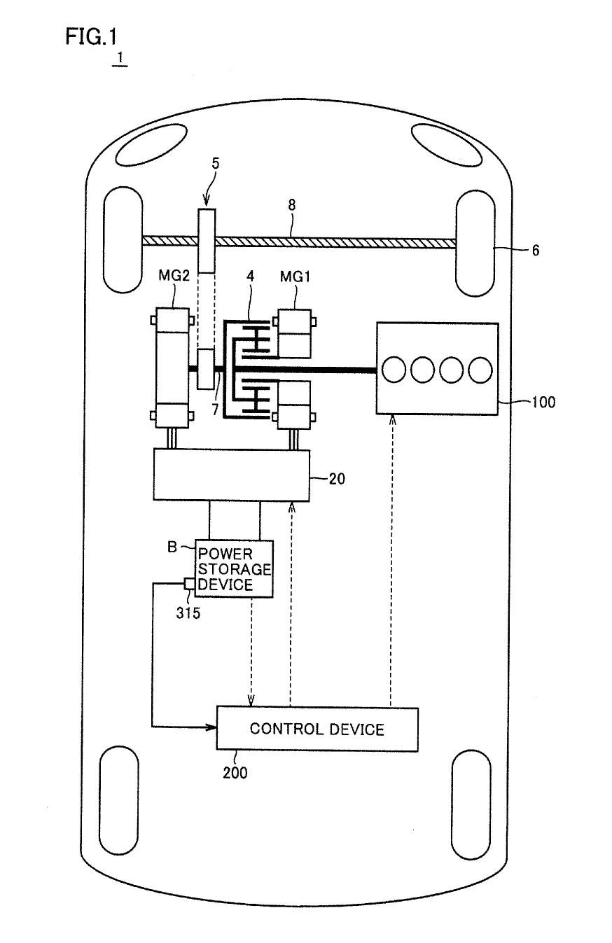

FIG. 1 is a block diagram generally showing a configuration of a hybrid vehicle according to an embodiment of the present invention.

With reference to FIG. 1, a hybrid vehicle 1 includes an engine 100, motor generators MG1 and MG2, a power split device 4, a speed reducer 5, a driving wheel 6, a power storage device B, a power control unit (PCU) 20, and a control device 200.

Engine 100 is for example an internal combustion engine such as a gasoline engine or a diesel engine.

Power split device 4 is configured to be capable of receiving the motive power that engine 100 generates, and dividing it to a path via an output shaft 7 to a drive shaft 8 and a path to motor generator MG1. Power split device 4 can be a planetary gear mechanism having three rotation shafts, i.e., a sun gear, a planetary gear and a ring gear. For example, motor generator MG1 can have a rotor hollowed to have a center allowing engine 100 to have a crankshaft passing therethrough to allow power split device 4 to have engine 100 and motor generators MG1 and MG2 mechanically connected thereto.

Specifically, motor generator MG1 has the rotor connected to the sun gear, engine 100 has an output shaft connected to the planetary gear, and output shaft 7 is connected to the ring gear. Output shaft 7, also connected to the rotation shaft of motor generator MG2, is mechanically coupled via speed reducer 5 to drive shaft 8 for rotating and thus driving driving wheel 6. Note that a speed reducer may further be incorporated between the rotation shaft of motor generator MG2 and output shaft 7.

Motor generator MG1, MG2 is an alternating current (AC) rotating electric machine, and is a three-phase ac synchronous, electrically motored power generator, for example. Motor generator MG1 operates as an electric power generator driven by engine 100 and also operates as an electric motor for starting engine 100, i.e., it is configured to function as an electric motor and an electric power generator.

Similarly, motor generator MG2 generates vehicular driving force transmitted to driving wheel 6 via speed reducer 5 and drive shaft 8. Furthermore, motor generator MG2 is configured to have a function of an electric motor and that of an electric power generator to generate an output torque opposite in direction to a direction in which driving wheel 6 rotates to regenerate electric power.

In the FIG. 1 exemplary configuration, motor generator MG1 can use power storage device B as a power supply to provide a torque (or cranking torque) to the output shaft (or crankshaft) of engine 100. In other words, motor generator MG1 is configured to be capable of starting engine 100. Motor generator MG1 is mechanically coupled with drive shaft 8 of hybrid vehicle 1 and the output shaft of engine 100 via a motive power transmission gear exemplified by power split device 4.

Power storage device B is a chargeably and dischargeably configured electric power storage element. Power storage device B for example includes a rechargeable battery such as a lithium ion battery, a nickel metal hydride battery or a lead acid battery, or a cell of a power storage element such as an electric double layer capacitor. Power storage device B is provided with a sensor 315 for sensing the power storage device B's temperature, current, and voltage. Sensor 315 senses the temperature, current, and voltage and outputs a value thereof to control device 200. Control device 200 receives the value from sensor 315 and uses the value to calculate a state of charge (SOC) of power storage device B. The SOC is typically indicated by a currently available capacity of power storage device B relative to a full charge capacity of power storage device B in percentages.

Power storage device B is connected to PCU 20 provided for driving motor generators MG1 and MG2. Power storage device B supplies PCU 20 with electric power for generating force to drive hybrid vehicle 1. Furthermore, power storage device B stores electric power generated by motor generators MG1, MG2. Power storage device B outputs 200 V for example.

PCU 20 receives direct current (DC) electric power from power storage device B and converts the received DC electric power into alternating current (AC) electric power to drive motor generators MG1 and MG2. PCU 20 also receives AC electric power generated by motor generators MG1 and MG2 and converts the received AC electric power into DC electric power to charge power storage device B therewith.

Control device 200 controls the outputs of engine 100 and motor generators MG1 and MG2, depending on how the vehicle travels. In particular, control device 200 controls hybrid vehicle 1 to travel to allow the vehicle to travel with engine 100 stopped and motor generator MG2 serving as a source of motive power, i.e., to travel as an EV, and to travel with engine 100 in operation, i.e., to travel as an HV, in combination.

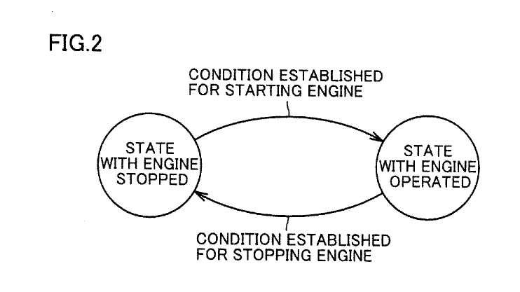

FIG. 2 is a transition diagram for illustrating how an intermittent engine operation is controlled in the hybrid vehicle shown in FIG. 1.

With reference to FIG. 2, hybrid vehicle 1 basically has engine 100 started and stopped as automatically controlled depending on how the vehicle travels. When vehicle 1 is in a state with the engine stopped and in that condition a condition is established for starting the engine, control device 200 generates an instruction to start the engine. This starts an engine starting process and hybrid vehicle 1 transitions from the state with the engine stopped to a state with the engine operated.

In contrast, when vehicle 1 is in the state with the engine operated and in that condition a condition is established for stopping the engine, control device 200 generates an instruction to stop the engine. This starts an engine stopping process and hybrid vehicle 1 transitions from the state with the engine operated to the state with the engine stopped.

For example, the condition for starting the engine, for hybrid vehicle 1, is determined by comparing with a threshold value an output parameter Pr used to quantitatively indicate an output (power or torque) that hybrid vehicle 1 is required to provide. In other words, the condition for starting the engine is established when output parameter Pr exceeds a prescribed threshold value Pth1.

For example, output parameter Pr is total required power Pt1 of hybrid vehicle 1. Total required power Pt1 can be calculated as follows: a required torque Tr* reflecting an amount by which the driver operates the accelerator pedal is multiplied by the rotational speed of drive shaft 8 to obtain required driving power Pr*, which and a required charged and discharged power Pchg for controlling power storage device B in SOC are added together (i.e., Pt1=Pr*+Pchg).

Required torque Tr* is set to higher values for larger amounts by which the accelerator pedal is operated. Furthermore, preferably, for a given amount by which the accelerator pedal is operated, in combination with vehicular speed, required torque Tr* is set to have smaller values for higher vehicular speeds. Alternatively, required torque Tr* can also be set in accordance with a previously set map or operation expression, depending on a road surface condition (a road surface gradient, a road surface friction coefficient, and the like).

Required charged and discharged power Pchg is set to be larger than zero for charging power storage device B when it has an SOC decreased to be lower than a control target value or range, whereas required charged and discharged power Pchg is set to be smaller than zero (or the power storage device is discharged) when it has an increased SOC. In other words, required charged and discharged power Pchg is set to allow power storage device B to have an SOC close to a prescribed control target (value or range).

Control device 200 controls the outputs of engine 100 and motor generators MG1 and MG2 to generate total required power Pt1. For example, when total required power Pt1 is small, such as when the vehicle travels at low speed, engine 100 is stopped. In contrast, when the accelerator pedal is operated for acceleration, total required power Pt1 increases, and accordingly, the condition for starting the engine is established, and engine 100 is thus started. Note that the condition for starting the engine is also established and engine 100 is thus also started when engine 100 is at low temperature or the like and accordingly, it is necessary to heat a three-way catalyst 112.

On the other hand, the condition for stopping the engine is established when output parameter Pr (total required power Pt1) is decreased to be lower than a prescribed threshold value Pth2. Note that preferably, threshold value Pth1 applied for the condition for starting the engine has a value different from that of threshold value Pth2 applied for the condition for stopping the engine (i.e., Pth1>Pth2) to prevent frequently switching the state with the engine stopped to the state with the engine operated and vice versa.

The engine is started to warm three-way catalyst 112 or the like, and once the catalyst or an engine coolant has been heated to be higher in temperature (as sensed by water temperature sensor 309) than a prescribed temperature, the condition for stopping the engine is established. Furthermore, the condition for stopping the engine is also established when the user operates a key switch and accordingly, driving the vehicle is stopped (e.g., when an IG switch is turned off).

Thus, once hybrid vehicle 1 has conditions established for starting and stopping the engine, hybrid vehicle 1 has engine 100 started and stopped as controlled and can thus achieve better fuel economy. More specifically, output parameter Pr can be considered, as described above, so that at a low output, which is when the engine's efficiency is decreased, operating engine 100 is avoided by intermittently driving engine 100 to reduce its fuel consumption.

Note that whether engine 100 is operated or stopped may be determined with reference to output parameter Pr other than total required power Pt1 described above. For example, output parameter Pr may be a required torque or acceleration calculated via reflecting at least by how much amount the accelerator pedal is operated, or output parameter Pr may be by how much amount the accelerator pedal is operated per se. Furthermore, engine 100 may intermittently be operated under any other conditions than those described above by way of example for starting and stopping the engine.

Hereinafter will be described how an engine having a variable valve actuation device is configured.

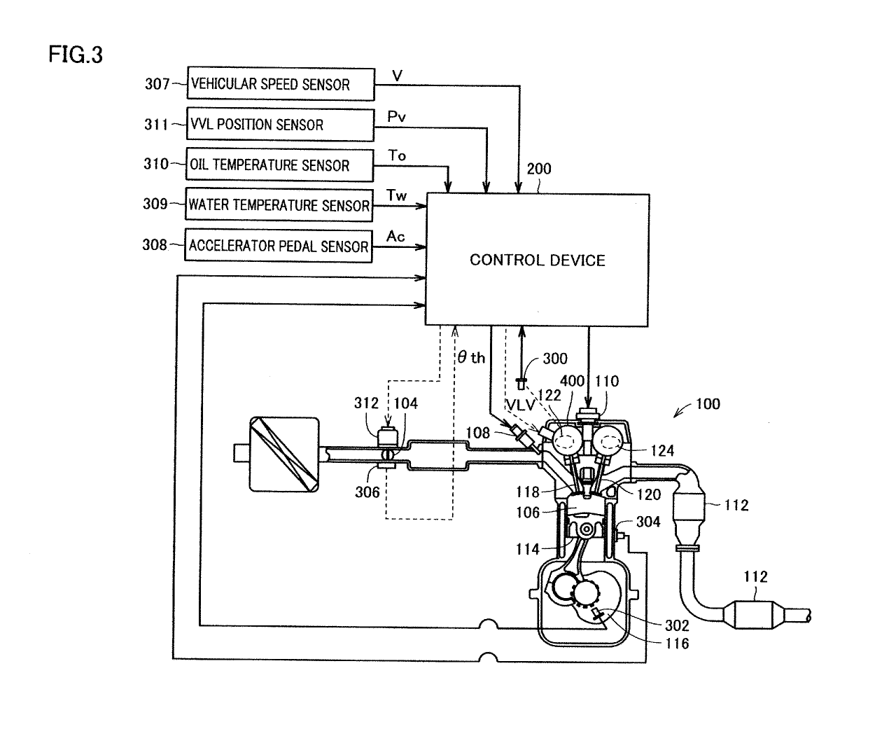

FIG. 3 shows a configuration of engine 100 shown in FIG. 1.

With reference to FIG. 3, how much amount of air is taken into engine 100 is adjusted by a throttle valve 104. Throttle valve 104 is an electronically controlled throttle valve driven by a throttle motor 312.

An injector 108 injects fuel towards an air intake port. At the intake port, the fuel is mixed with air. The air-fuel mixture is introduced into cylinder 106 when intake valve 118 opens.

Note that injector 108 may be provided as a direct injection injector to inject fuel directly into cylinder 106. Alternatively, injector 108 may be provided for both port injection and direct injection.

Cylinder 106 receives the air-fuel mixture, which is ignited by an ignition plug 110 and thus combusted. The combusted air-fuel mixture, or exhaust gas, is purified by three-way catalyst 112 and subsequently discharged outside the vehicle. As the air-fuel mixture is combusted, a piston 114 is pushed down and a crankshaft 116 thus rotates.

Cylinder 106 has a head or top portion provided with intake valve 118 and an exhaust valve 120. When and in what amount cylinder 106 receives air is controlled by intake valve 118. When and in what amount cylinder 106 discharges exhaust gas is controlled by exhaust valve 120. Intake valve 118 is driven by a cam 122. Exhaust valve 120 is driven by a cam 124.

Intake valve 118 has an actuation characteristic, as controlled by a variable valve lift (VVL) device 400, as will more specifically be described hereinafter. Hereinafter, intake valve 118 has the actuation characteristic controlled as an amount of lifting the intake valve and a working angle on the intake valve by way of example. Note that exhaust valve 120 may also be lifted in an amount and/or worked by a working angle, as controlled. Furthermore, a variable valve timing (VVT) device may be combined with VVL device 400 to control timing when the valve should be opened/closed.

Control device 200 controls a throttle angle θth, timing when to provide ignition, timing when to inject fuel, the amount of fuel to be injected, the intake valve's operating condition (timing when to open/close the valve, the amount of lifting it, the working angle, and the like) to allow engine 100 to achieve a driving state as desired. Control device 200 receives signals from a cam angle sensor 300, a crank angle sensor 302, a knock sensor 304, a throttle angle sensor 306, a vehicular speed sensor 307, an accelerator pedal sensor 308, a water temperature sensor 309, an oil temperature sensor 310, and a VVL position sensor 311.

Cam angle sensor 300 outputs a signal indicating a cam's position. Crank angle sensor 302 outputs a signal indicating the rotational speed of crankshaft 116 (or the engine's rotational speed) and the angle of rotation of crankshaft 116. Knock sensor 304 outputs a signal indicating how engine 100 vibrates in intensity. Throttle angle sensor 306 outputs a signal indicating throttle angle θth.

Water temperature sensor 309 senses temperature Tw of a water coolant of engine 100. Oil temperature sensor 310 senses temperature To of a lubricant oil of engine 100. The water coolant's temperature Tw and the lubricant oil's temperature To that are sensed are input to control device 200. Accelerator pedal sensor 308 senses by how much amount Ac the driver operates the accelerator pedal (not shown). Vehicular speed sensor 307 senses vehicular speed V of hybrid vehicle 1 from the rotational speed of drive shaft 8 and the like. Amount Ac by which the accelerator pedal is operated, as sensed by accelerator pedal sensor 308, and vehicular speed V as sensed by vehicular speed sensor 307, are input to control device 200.

Furthermore, VVL position sensor 311 is configured to sense data Pv indicating the current actuation characteristic of intake valve 118 controlled by VVL device 400. Data Pv sensed by VVL position sensor 311 is input into control device 200. That is, control device 200 can detect the current value of the amount of lifting the intake valve and that of the working angle on the intake valve from data Pv received from VVL position sensor 311.

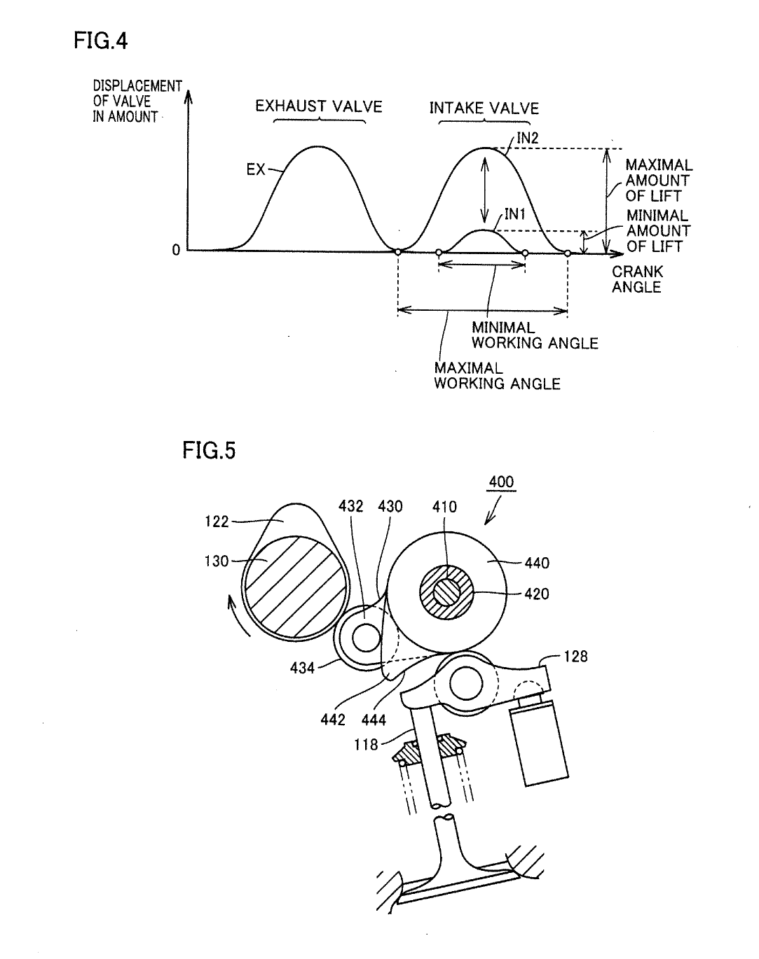

FIG. 4 represents a relationship, as implemented in VVL device 400, between a valve's displacement in amount and crank angle. With reference to FIG. 4, for the exhaust stroke, exhaust valve 120 opens and closes, and for the intake stroke, intake valve 118 opens and closes. Exhaust valve 120 displaces in an amount represented by a waveform EX, and intake valve 118 displaces in amounts represented by waveforms IN1 and IN2.

The valve's displacement in amount indicates an amount by which intake valve 118 is displaced from its closed position. The amount of lift indicates an amount by which intake valve 118 is displaced when the valve peaks in how much in degree it is opened. The working angle is a crank angle assumed after intake valve 118 is opened before it is closed.

Intake valve 118 has an actuation characteristic varied by VVL device 400 between waveforms IN1 and IN2. Waveform IN1 corresponds to a minimal amount of lift and a minimal working angle. Waveform IN2 corresponds to a maximal amount of lift and a maximal working angle. In VVL device 400, a larger amount of lift is accompanied by a larger working angle. In other words, the present embodiment presents VVL device 400 by way of example to allow intake valve 118 to be lifted in an amount and worked by a working angle as an actuation characteristic of intake valve 118, as modified in VVL device 400.

FIG. 5 is a front view of VVL device 400 serving as an exemplary device that controls an amount of lifting intake valve 118 and a working angle on intake valve 118.

With reference to FIG. 5, VVL device 400 includes a driving shaft 410 extending in one direction, a support pipe 420 that covers driving shaft 410 circumferentially, and an input arm 430 and a rocking cam 440 disposed in alignment on an outer circumferential surface of support pipe 420 in a direction along the axis of driving shaft 410. Driving shaft 410 has a tip with an actuator (not shown) connected thereto to cause driving shaft 410 to provide rectilinear motion.

VVL device 400 is provided with a single input arm 430 associated with a single cam 122 provided for each cylinder. Input arm 430 has opposite sides provided with two rocking cams 440 associated with a pair of intake valves 118, respectively, provided for each cylinder.

Support pipe 420 is formed in a hollowed cylinder and disposed in parallel to a cam shaft 130. Support pipe 420 is secured to a cylinder head and thus prevented from axially moving or rotating.

Support pipe 420 internally receives driving shaft 410 to allow driving shaft 410 to slide axially. Support pipe 420 has an outer circumferential surface provided thereon with input arm 430 and two rocking cams 440 to be rockable about an axial core of driving shaft 410 and also prevented from moving in a direction along the axis of driving shaft 410.

Input arm 430 has an arm portion 432 projecting in a direction away from the outer circumferential surface of support pipe 420, and a roller portion 434 rotatably connected to a tip of arm portion 432. Input arm 430 is provided to allow roller portion 434 to be disposed at a position allowing roller portion 434 to abut against cam 122.

Rocking cam 440 has a nose portion 442 in a generally triangular form projecting in a direction away from the outer circumferential surface of support pipe 420. Nose portion 442 has one side having a recessed, curved cam surface 444. Intake valve 118 is provided with a valve spring, which is biased to apply force to in turn press against cam surface 444 a roller rotatably attached to a rocker arm 128.

Input arm 430 and rocking cam 440 rock together about the axial core of driving shaft 410. Accordingly, as cam shaft 130 rotates, input arm 430 that abuts against cam 122 rocks, and as input arm 430 thus moves, rocking cam 440 also rocks. This motion of rocking cam 440 is transmitted via rocker arm 128 to intake valve 118 to thus open/close intake valve 118.

VVL device 400 further includes a device around the axial core of support pipe 420 to vary a relative phase difference between input arm 430 and rocking cam 440. The device that varies the relative phase difference allows intake valve 118 to be lifted in an amount and worked by a working angle, as modified as appropriate.

More specifically, input arm 430 and rocking cam 440 with an increased relative phase difference allow rocker arm 128 to have a rocking angle increased relative to that of input arm 430 and rocking cam 440 and intake valve 118 to be lifted in an increased amount and worked by an increased working angle.

In contrast, input arm 430 and rocking cam 440 with a reduced relative phase difference allow rocker arm 128 to have a rocking angle reduced relative to that of input arm 430 and rocking cam 440 and intake valve 118 to be lifted in a reduced amount and worked by a reduced working angle. For example, VVL position sensor 311 can be configured to sense a mechanical relative phase difference between input arm 430 and rocking cam 440 as data Pv. Note that VVL position sensor 311 may have any configuration that allows its sensed value to be used to directly or indirectly obtain the actuation characteristic of intake valve 118, i.e., the amount of lifting intake valve 118 and the working angle on intake valve 118.

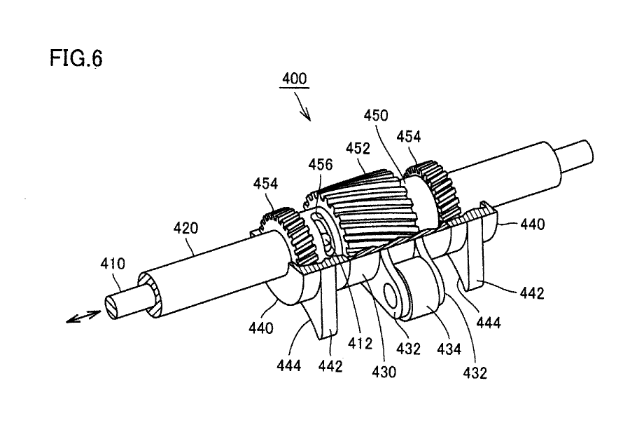

FIG. 6 is a partial perspective view of VVL device 400. FIG. 6 shows VVL device 400 partially exploded to help to clearly understand its internal structure.

With reference to FIG. 6, input arm 430 and two rocking cams 440, and an outer circumferential surface of support pipe 420 define a space therebetween, and in that space, a slider gear 450 is accommodated that is supported to be rotatable relative to support pipe 420 and also axially slidable. Slider gear 450 is provided slidably on support pipe 420 axially.

Slider gear 450 as seen axially has a center provided with a helically right handed splined helical gear 452. Slider gear 450 as seen axially also has opposite sides provided with helically left handed splined helical gears 454s, respectively, with helical gear 452 posed therebetween.

An internal circumferential surface of input arm 430 and two rocking cams 440 that defines the space that has slider gear 450 accommodated therein, is helically splined to correspond to helical gears 452 and 454. More specifically, input arm 430 is helically right handed splined to mesh with helical gear 452. Furthermore, rocking cam 440 is helically left handed splined to mesh with helical gear 454.

Slider gear 450 is provided with an elongate hole 456 located between one helical gear 454 and helical gear 452 and extending circumferentially. Furthermore, although not shown, support pipe 420 is provided with an elongate hole extending axially and overlapping a portion of elongate hole 456. Driving shaft 410, inserted in support pipe 420, is integrally provided with a locking pin 412 to project through those portions of elongate hole 456 and the unshown elongate hole which overlap each other.

Driving shaft 410 is coupled with an actuator (not shown), and when the actuator is operated, driving shaft 410 moves in its axial direction, and accordingly, slider gear 450 is pushed by locking pin 412 and helical gears 452 and 454 move in a direction along the axis of driving shaft 410 concurrently. While helical gears 452 and 454 are thus moved, input arm 430 and rocking cam 440 splined and thus engaged therewith do not move in the axial direction. Accordingly, input arm 430 and rocking cam 440, helically splined and thus meshed, pivot about the axial core of driving shaft 410.

Note that input arm 430 and rocking cam 440 are helically splined in opposite directions, respectively. Accordingly, input arm 430 and rocking cam 440 pivot in opposite directions, respectively. This allows input arm 430 and rocking cam 440 to have a relative phase difference varied to allow intake valve 118 to be lifted in a varying amount and worked by a varying working angle, as has been previously described.

For example, VVL position sensor 311 shown in FIG. 3 is configured to have a mechanism capable of sensing a mechanical phase difference between input arm 430 and rocking cam 440. Alternatively, VVL position sensor 311 can also be configured to have a mechanism capable of sensing an axial position of driving shaft 410 moved by an actuator (not shown).

Control device 200 controls by how much amount the actuator that causes driving shaft 410 to move in rectilinear motion should be operated to control the amount of lifting intake valve 118 and the working angle on intake valve 118. The actuator can for example be an electric motor. In that case, the actuator or electric motor typically receives electric power from a battery (an auxiliary battery) other than power storage device B. Alternatively, the actuator can also be configured to be operated by the hydraulic pressure generated from an oil pump driven by engine 100.

Note that the VVL device is not limited to the form exemplified in FIGS. 5 and 6. For example, the VVL device may be a VVL device which electrically drives the valve, a VVL device which hydraulically drives the valve, or the like. In other words, in the present embodiment, intake valve 118 may have the actuation characteristic (or be lifted in an amount and worked by a working angle) varied by any scheme, and any known scheme may be applied as appropriate.

The intake valve's actuation characteristic and the engine's operation have a relationship, as will be described hereinafter.

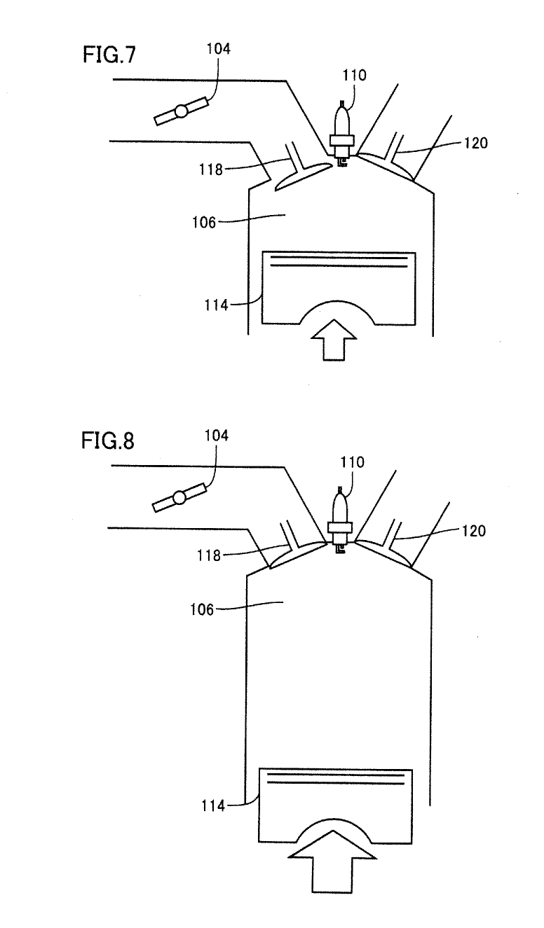

FIG. 7 provides a representation for illustrating an operation provided when intake valve 118 is lifted in a large amount and worked by a large working angle. FIG. 8 provides a representation for illustrating an operation provided when intake valve 118 is lifted in a small amount and worked by a small working angle.

With reference to FIGS. 7 and 8, when intake valve 118 is lifted in a large amount and worked by a large working angle, intake valve 118 is timed to close late, and accordingly, engine 100 is operated in the Atkinson cycle. More specifically, the intake stroke is performed to allow cylinder 106 to take in air, which is partially returned outside cylinder 106, and accordingly, the compression stroke is performed with the air compressed by a reduced force, i.e., with a reduced compressive reaction (i.e., a decompression effect). This allows the engine to be started with reduced vibration. The hybrid vehicle has engine 100 operated intermittently and accordingly, the engine starting process is performed more frequently, and accordingly, it is preferable that the engine be started with intake valve 118 lifted in an increased amount and worked by an increased working angle.

In contrast, when intake valve 118 is lifted in a small amount and worked by a small working angle, intake valve 118 is timed to close early, and accordingly, an increased compression ratio is provided. This can improve ignitability for low temperature and also improve engine torque response. Accordingly, starting the engine with intake valve 118 lifted in a smaller amount and worked by a smaller working angle ensures that the engine starts. On the other hand, lifting intake valve 118 in a small amount and working it by a small working angle provide an increased compressive reaction, and hence increased vibration in starting the engine.

While FIG. 7 and FIG. 8 show a characteristic provided when VVL device 400 allows intake valve 118 to be lifted in a varying (or increasing and decreasing) amount and worked by a varying (or increasing and decreasing) working angle, either lifting intake valve 118 in a varying (or increasing and decreasing) amount or working intake valve 118 by a varying (or increasing and decreasing) working angle also allows a qualitatively equivalent feature to appear.

Motor generator MG1 operates to start engine 100, as will be described hereinafter.

When engine 100 in a stopped state is started by the engine starting process, engine 100 is cranked by motor generator MG1, as shown in FIG. 1. Accordingly, when the engine starting process is started with motor generator MG1 stopped or positively rotated, discharging power storage device B is involved, and motor generator MG1 outputs a positive torque to crank engine 100. In contrast, when the engine starting process is started with motor generator MG1 negatively rotated, charging power storage device B is involved, and motor generator MG1 outputs a negative torque to crank engine 100.

Motor generator MG1 thus generates a cranking torque, with power storage device B charged/discharged, to start the engine. Accordingly, when power storage device B is only allowed to be charged with and discharge limited electric power, motor generator MG1 also generates a cranking torque limited in magnitude (or absolute value). Generally, power storage device B is charged/discharged as limited by a limit value set as an upper limit value Wout for electric power discharged and an upper limit value Win for electric power charged.

Upper limit value Wout for electric power discharged indicates an upper limit value set for electric power discharged, and it is set to be equal to or larger than zero. Wout=0 means that discharging power storage device B is prohibited. Similarly, upper limit value Win for electric power charged indicates an upper limit value set for electric power charged, and it is set to be equal to or smaller than zero. Win=0 means that charging power storage device B is prohibited.

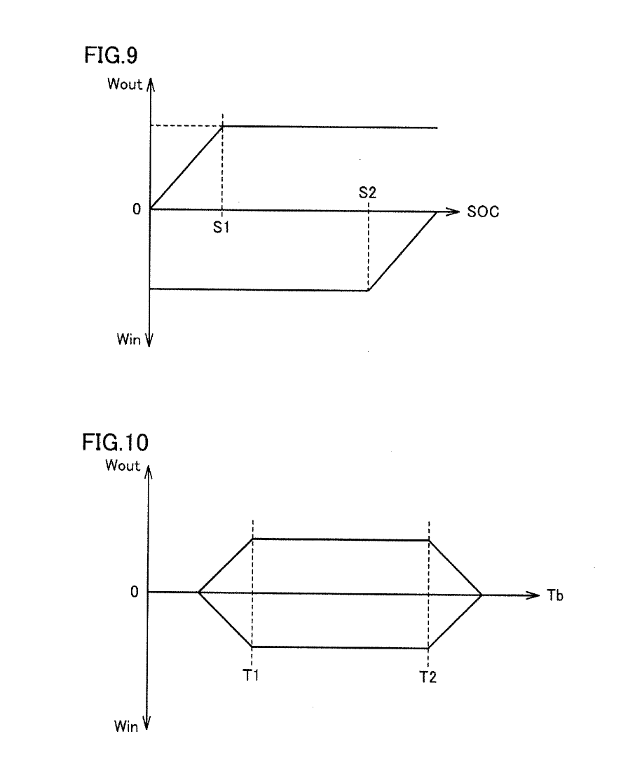

FIGS. 9 and 10 provide representations for illustrating how power storage device B is limited in performance. FIG. 9 represents how upper limit value Wout for electric power discharged and upper limit value Win for electric power charged are limited with respect to the SOC of power storage device B, and FIG. 10 represents how upper limit value Wout for electric power discharged and upper limit value Win for electric power charged are limited with respect to temperature Tb of power storage device B.

With reference to FIG. 9, for a low SOC range (SOC<S1), discharging power storage device B is limited, and to do so, upper limit value Wout for electric power discharged is set to be lower than for a range of SOC≧S1. Similarly, for a high SOC range (SOC>S2), charging power storage device B is limited, and to do so, upper limit value Win for electric power charged is set to be smaller in absolute value than for a range of SOC≦S2.

With reference to FIG. 10, when power storage device B is a rechargeable battery, then, at low temperature and high temperature, the battery has an increased internal resistance, and upper limit value Wout for electric power discharged and upper limit value Win for electric power charged are limited. For example, upper limit value Wout for electric power discharged and upper limit value Win for electric power charged are limited when power storage device B has temperature Tb in a low temperature range (Tb<T1) and a high temperature range (Tb>T2) as compared with an ordinary temperature range (T1 Tb T2).

Power storage device B's SOC and/or temperature Tb are/is thus considered in limiting power storage device B in performance to reduce electric power charged/discharged to/from power storage device B. Motor generators MG1 and MG2 each produce a torque controlled by a value limited such that motor generators MG1 and MG2 have a sum of their input and output electric powers (i.e., torque×rotational speed) falling within a range between Win and Wout to protect power storage device B.

In the present embodiment, when intake valve 118 having an actuation characteristic controlled by VVL device 400 has the actuation characteristic fixed for some reason, and the engine is started in that condition, the engine causes vibration perceived by and giving discomfort to the user. The present embodiment provides control to alleviate such discomfort. Note that, as has been described previously, the present embodiment presents VVL device 400 by way of example to control an actuation characteristic of intake valve 118 that is an amount of lifting intake valve 118 and a working angle on intake valve 118.

When VVL device 400 has failed or been stuck at extremely low temperature or the like and accordingly, intake valve 118 has a fixed actuation characteristic such that it is lifted in a smaller amount and worked by a smaller working angle than a prescribed value (see FIG. 8) (hereinafter also referred to as “when the valve is actuated in a small, fixed amount”), and in that condition the engine is started, it provides increased vibration. If in that condition engine 100 is intermittently operated, and it is intermittently stopped and subsequently restarted, it may causes vibration giving discomfort to the user. On the other hand, unconditionally prohibiting engine 100 from intermittently stopping, as described in Japanese Patent Laying-Open No. 2009-202662, may result in impaired fuel economy.

Accordingly, in the present embodiment, when intake valve 118 is actuated in a small, fixed amount, whether the vehicle has such a vehicular state that when the engine is started it provides a shock to give significant discomfort to the user (hereinafter also referred to as “a state inviting aggravated engine start shock”), is determined. Intermittently stopping engine 100 is prohibited only when the vehicle is in the state inviting aggravated engine start shock. More specifically, intermittently stopping engine 100 is not unconditionally prohibited and is instead permitted when engine 100 can be started without vibration giving substantial discomfort to the user.

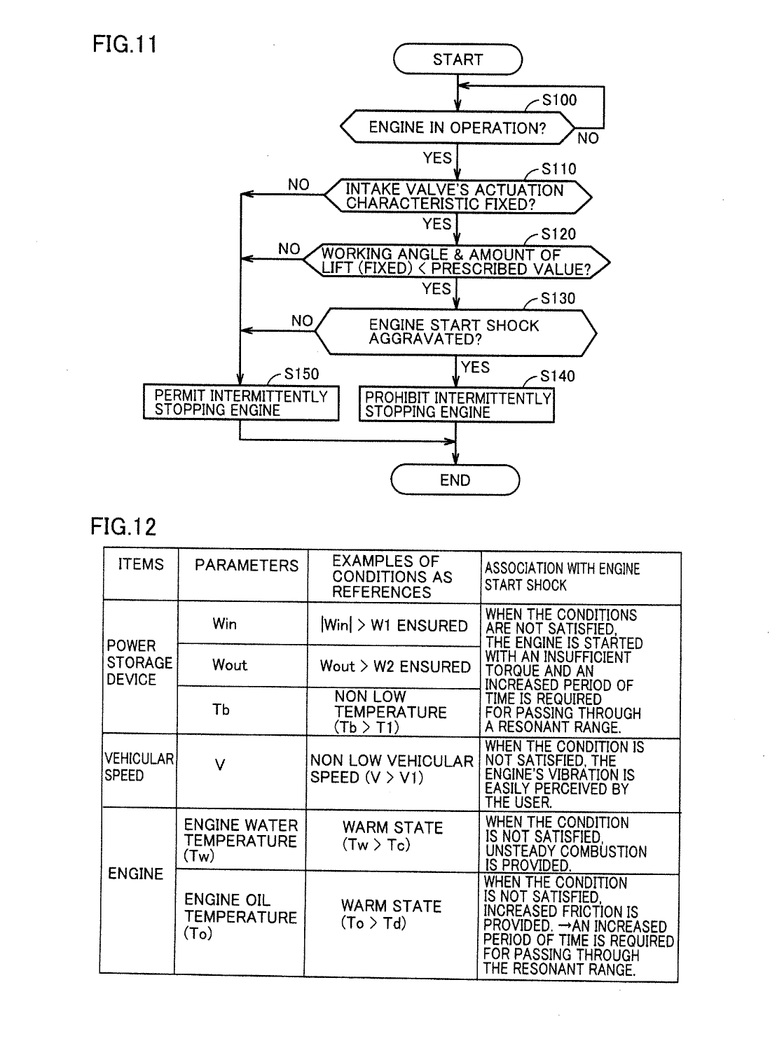

FIG. 11 is a flowchart of a process for controlling an intermittent engine operation in the hybrid vehicle according to the present embodiment. The FIG. 11 process can be performed by control device 200.

With reference to FIG. 11, when the engine is in operation, i.e., for YES in Step S100, control device 200 proceeds to Step S110 et. seq. When the engine is in operation (YES in Step S100), control device 200 proceeds to Step S110 to determine whether the actuation characteristic of intake valve 118 controlled by VVL device 400 is fixed for some reason. For example, a decision of YES is made for Step S110 when VVL position sensor 311 provides an output that is unchanged for more than a prescribed period of time in a state different from a control value issued to VVL device 400 to lift the intake valve in an amount and work the intake valve by a working angle. As described above, in Step S110, a decision of YES can be made not only when VVL device 400 has failed but also when low temperature or the like results in a temporarily fixed actuation characteristic while VVL device 400 normally operates.

When the intake valve has the actuation characteristic fixed (YES in S110), control device 200 proceeds to Step S120 to determine from an output of VVL position sensor 311 whether the intake valve that is lifted in a fixed amount and worked by a fixed working angle is lifted in a smaller amount and worked by a smaller working angle than a prescribed value (a threshold value). If intake valve 118 is lifted in a smaller amount and worked by a smaller working angle than the threshold value, control device 200 makes a decision of YES for S120 and thus detects that intake valve 118 is actuated in a small, fixed amount, as has been previously described.

When control device 200 detects that intake valve 118 is actuated in the small, fixed amount (YES in S120), control device 200 proceeds to Step S130 to determine whether the vehicle is in a state inviting aggravated engine start shock. For example, in Step S130, a prescribed condition indicated in FIG. 12 by way of example is referred to to determine whether the vehicle is in the state inviting aggravated engine start shock.

FIG. 12 is a table for describing the prescribed condition for determining whether the vehicle is in the state inviting aggravated engine start shock.

When the engine is started with an insufficient cranking torque applied, the engine may be started with increased vibration. Furthermore, when hybrid vehicle 1 is traveling at low vehicular speed, and the engine is started, the engine may be started with vibration easily perceived by and thus giving discomfort to the user.

Generally, engine 100 provides vibration excited by the resonance of the suspension system of engine 100, the torsional resonance of the drive train, and the like. These resonances are generated at a natural frequency (a so-called resonant frequency) determined by a mechanism's geometry, mass, and the like. Accordingly, it is preferable that the engine be started with a sufficient cranking torque ensured to allow the engine to have rotational speed increased at a rate increased to allow rotational speed to pass through in a short period of time a resonant engine speed range (a resonant range) corresponding to that resonant frequency. In contrast, when the engine is started with an insufficient cranking torque applied and as a result the engine cannot have rapidly increasing rotational speed, passing through the resonant range requires an increased period of time and as a result the engine may be started with significant vibration.

Accordingly, as indicated in FIG. 12, a state of power storage device B that is indicated by upper limit value Win for electric power charged, upper limit value Wout for electric power discharged, and temperature Tb is referred to to determine whether such a sufficient cranking torque as described above is ensured. For example, when at least any one of |Win|>W1 (a first condition), Wout (more specifically, |Wout|)>W2 (a second condition), and Tb>T1 (a third condition) has been established, it can be determined that the engine can be started with the cranking torque ensured. Note that W1 and W2 are prescribed values predetermined through an experiment performed in a real machine or the like, and T1 is a prescribed value predetermined for determining that power storage device B is not in a low temperature condition that imposes limitation on charging and discharging power storage device B. Note that, for temperature Tb, Tb>T1 is at least determined as the third condition. This is because at high temperature, engine 100 is in a warm state, and there is a tendency that the engine is not started with increased vibration. Alternatively, Tb>T1 and Tb<T2 may together be set as the third condition in view of the FIG. 10 characteristic.

In contrast, when none of the first to third conditions is established, it can be determined that the engine is started with an insufficient cranking torque applied.

Furthermore, at a low vehicular speed, there is a tendency that the vehicle's cabin is in a quiet condition, and accordingly, a level of vibration caused when the engine is started at the low vehicular speed is more easily perceived by the user than the same level of vibration caused when the engine is started at intermediate and high vehicular speeds (or a non low vehicular speed). For example, vehicular speed V sensed by vehicular speed sensor 307 (see FIG. 3) is compared with a prescribed reference value V1, and when V>V1 (a fourth condition) is established, it can be determined that the vehicle is traveling at the non low vehicular speed.

Accordingly, the FIG. 11 Step S130 can be performed for example as follows: when an insufficient cranking torque is provided and hybrid vehicle 1 is traveling at low vehicular speed, i.e., when none of the first to fourth conditions is established, it can be determined that the vehicle is in the state inviting aggravated engine start shock (YES in S130). In contrast, when at least any one of the first to fourth conditions is established, it can be determined that the vehicle is not in the state inviting aggravated engine start shock (NO in S130).

Furthermore, when engine 100 is at low temperature, the engine is in a cold state and thus provides less steady combustion, and when the engine is started in that condition, the engine easily provides vibration. Furthermore, as friction increases, a cranking torque is applied with the engine having rotational speed increasing at a decreased rate and accordingly abiding within the resonant engine speed range for a long period of time and as a result the engine may be started with significant vibration.

For example, the engine's water coolant temperature Tw sensed by water temperature sensor 309 (see FIG. 3) can be compared with a prescribed reference value Tc, and when Tw≦Tc, it can be determined that the engine is in the cold state. Furthermore, the engine's lubricant oil temperature To sensed by oil temperature sensor 310 (see FIG. 3) can be compared with a prescribed reference value Td, and when To≦Td, it can be determined that the engine has large friction.

In contrast, when engine 100 is not at low temperature, the engine provides steady combustion and has limited friction, and therefrom it can be expected that the engine can be started without vibration increased to a level giving discomfort to the user while an insufficient cranking torque is applied and hybrid vehicle 1 is also traveling at a low vehicular speed. Accordingly, it is preferable that engine 100 be intermittently operated in view of better fuel economy.

Accordingly, the FIG. 11 Step S130 in an exemplary variation can be performed to sense the engine's warm state (or non cold state), as follows: when at least any one of Tw>Tc (a fifth condition) and To>Td (a sixth condition) has been established it can be determined that the vehicle is not in the state inviting aggravated engine start shock (NO in S130). In that case, when none of the first to sixth conditions is established, it can be determined that the vehicle is in the state inviting aggravated engine start shock (YES in S130).

With reference again to FIG. 11, when control device 200 detects that intake valve 118 is actuated in the small, fixed amount (YES in S120), and it is determined that the vehicle is in the state inviting aggravated engine start shock (YES in S130), the control proceeds to Step S140 to prohibit intermittently stopping engine 100. In that case, in controlling the intermittent engine operation, as shown in FIG. 2, if the vehicle is in the state with the engine operated and the condition for stopping the engine has also been established, issuing the instruction to stop the engine is nonetheless prohibited. As a result, intermittently operating engine 100 is avoided when starting the engine easily provides vibration to give discomfort to the user.

On the other hand, when intake valve 118 does not have the actuation characteristic fixed but normally controlled (NO in S110), and in addition, when intake valve 118 has the actuation characteristic fixed (or is worked by a fixed working angle and lifted in a fixed amount), with the fixed amount and angle larger than a threshold value (NO in S120), then, the control proceeds to Step S150 to permit intermittently stopping engine 100. This is because in these cases, engine 100 can be started in the FIG. 7 condition and hence with reduced vibration.

Furthermore, when control device 200 determines that intake valve 118 is actuated in the small, fixed amount (YES in S120) and that the vehicle is not in the state inviting aggravated engine start shock (NO in S130), the control proceeds to Step S150 to permit intermittently stopping engine 100. This is because when the vehicle is not in the state inviting aggravated engine start shock it is less likely that the engine is started with vibration giving discomfort to the user.

When intermittently stopping engine 100 is permitted, then, as shown in FIG. 2, engine 100 can be intermittently operated for better fuel economy in response to the conditions for starting and stopping the engine being established depending on how the vehicle's driven state varies.

Thus the present embodiment provides a hybrid vehicle such that even when intake valve 118 is actuated in a small, fixed amount and accordingly engine 100 has an increased compression ratio, intermittently stopping engine 100 is not unconditionally prohibited and is instead permitted when engine 100 would be started without vibration giving substantial discomfort to the user.

Furthermore, when intake valve 118 has the actuation characteristic fixed (or is worked by a fixed working angle and lifted in a fixed amount), with the fixed angle and amount larger than a threshold value, and the engine can be started with a reduced compression ratio, intermittently stopping engine 100 is permitted.

As a result, when intake valve 118 having an actuation characteristic (or lifted in an amount and worked by a working angle) controlled by VVL device 400 has the actuation characteristic fixed, engine 100 can nonetheless be started with the user experiencing less discomfort, and in addition, better fuel economy can be achieved.

VVL Device in Exemplary Variation

In the present embodiment intake valve 118 may be lifted in an amount and worked by a working angle which may vary continuously (or steplessly) as described above or may be set discretely (or stepwise).

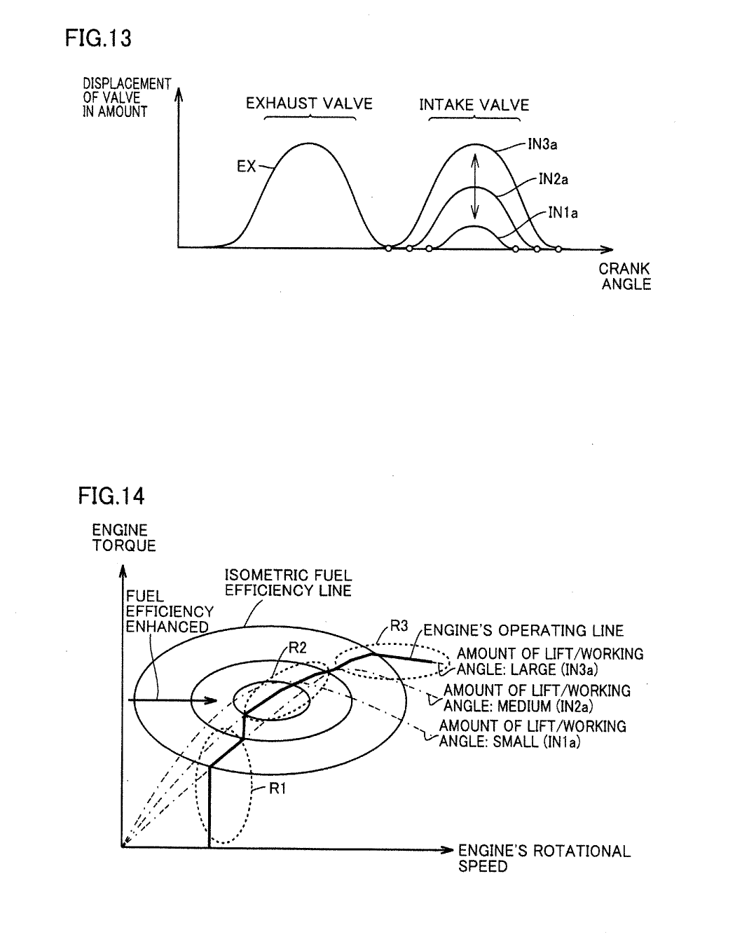

FIG. 13 represents a relationship between the valve's displacement in amount and crank angle, as implemented by a VVL device 400A that can vary intake valve 118's actuation characteristic in three levels.

VVL device 400A is capable of varying the actuation characteristic to any one of first to third characteristics. The first characteristic is represented by a waveform IN1a. The second characteristic is represented by a waveform IN2a and corresponds to a larger amount of lift and a larger working angle than the first characteristic. The third characteristic is represented by a waveform IN3a and corresponds to a larger amount of lift and a larger working angle than the second characteristic.

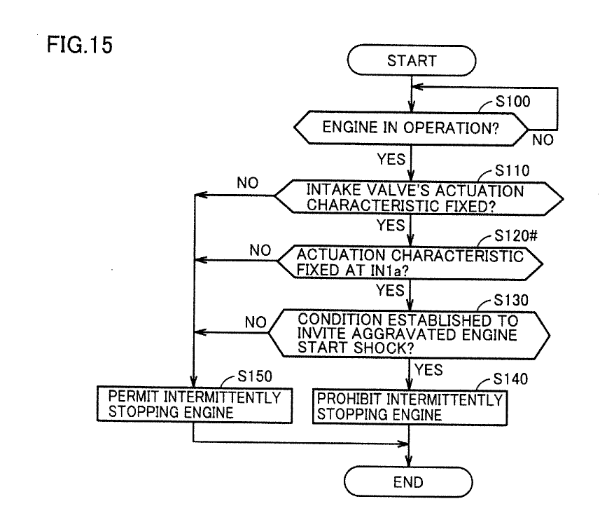

FIG. 14 shows an operating line of an engine including a VVL device having the actuation characteristic shown in FIG. 13.

In FIG. 14, the axis of abscissa represents the engine's rotational speed and the axis of ordinate represents engine torque. Note that in FIG. 14, alternate long and short dashed lines indicate torque characteristics corresponding to the first to third characteristics (IN1a-IN3a). Furthermore, in FIG. 14, a circle indicated by a solid line indicates an isometric fuel efficiency line. The isometric fuel efficiency line indicates connected points equal in fuel consumption, and a point closer to the center of the circle corresponds to more enhanced fuel efficiency. An engine 100A is basically operated on an engine operating line indicated in FIG. 14 by a solid line, for the sake of illustration.

Herein, a range R1 indicates a low rotational speed range, for which reducing a shock caused when the engine starts is important. Furthermore, exhaust gas recirculation (EGR) is ceased and the Atkinson cycle is applied for enhanced fuel efficiency. Accordingly, preferably, the third characteristic (IN3a) is selected as the actuation characteristic of intake valve 118 to provide an increased amount of lift and an increased working angle.

A range R2 indicates a medium rotational speed range, for which the EGR is applied to introduce exhaust gas in an increased amount for enhanced fuel efficiency. Accordingly, the second characteristic (IN2a) is selected as the actuation characteristic of intake valve 118 to provide an intermediate amount of lift and an intermediate working angle.

In other words, when intake valve 118 is lifted in a large amount and worked by a large working angle (i.e., the third characteristic is selected), enhancing fuel efficiency via the Atkinson cycle, rather than via the EGR, is prioritized. In contrast, when a medium amount of lift and a medium working angle are selected (i.e., the second characteristic is selected), enhancing fuel efficiency via the EGR, rather than via the Atkinson cycle, is prioritized.

A range R3 indicates a high rotational speed range, for which intake inertia is exploited to introduce a large amount of air into the cylinder to provide an increased actual compression ratio for better output performance. Accordingly, the third characteristic (IN3a) is selected as the actuation characteristic of intake valve 118 to provide an increased amount of lift and an increased working angle.

When engine 100A is operated in the low rotational speed range with a large load; engine 100A is started at cryogenic temperature; or a catalyst is warmed up, the first characteristic (IN1a) is selected as the actuation characteristic of intake valve 118 to provide a reduced amount of lift and a reduced working angle. Thus an amount of lift and a working angle are determined depending on how engine 100A is operated.

When the VVL device described with reference to FIG. 13 and FIG. 14 is applied, and intake valve 118 has an actuation characteristic (or is lifted in an amount and worked by a working angle), as controlled by VVL device 400A, fixed for some reason in accordance with the first characteristic (IN1a), intake valve 118 has a state equivalent to that provided when intake valve 118 is actuated in a small, fixed amount, as has previously been described, and the engine will be started with increased vibration.

FIG. 15 is a flowchart for illustrating a process for controlling an intermittent engine operation according to the present embodiment having applied thereto VVL device 400A having the FIG. 13 actuation characteristic.

With reference to FIG. 15, control device 200 performs the FIG. 11 process having Step S120 replaced with Step S120# to control intermittently operating engine 100.

Control device 200 proceeds to S100 and S110 similar to those of FIG. 11, and if the intake valve has the actuation characteristic fixed (YES in S110) the control proceeds to Step S120#.

Control device 200 in step S120# determines whether intake valve 118 has the actuation characteristic (or is worked by a working angle and lifted in an amount) fixed to a value corresponding to the first characteristic (IN1a). If intake valve 118 has the actuation characteristic fixed in accordance with the first characteristic (IN1a) (YES in S120#), then, as has been done for YES in Step S120, control device 200 detects that intake valve 118 is actuated in a small, fixed amount. Accordingly, the control proceeds to Step S130.

In contrast, if intake valve 118 has the actuation characteristic fixed in accordance with the second characteristic (IN2a) or the third characteristic (IN3a) (NO in S120#), the control proceeds to Step S150. Steps S130-S150 are similar to those of FIG. 11, and accordingly, will not be described repeatedly.

Thus, when intake valve 118 having an actuation characteristic switched in three levels by VVL device 400A has the actuation characteristic fixed in accordance with the first characteristic (IN1a), and the engine is started with an increased compression ratio, intermittently stopping engine 100 is not unconditionally prohibited and is instead permitted when the engine would be started without vibration giving substantial discomfort to the user.

Furthermore, when intake valve 118 has an actuation characteristic (or is worked by a working angle and lifted in an amount) fixed in accordance with the second characteristic (IN2a) or the third characteristic (IN3a), and the engine can be started with a reduced compression ratio, intermittently stopping engine 100 is permitted.

Consequently, when intake valve 118 having an actuation characteristic (or lifted in an amount and worked by a working angle) switched in three levels by VVL device 400A has the actuation characteristic (or is lifted in an amount and worked by a working angle) fixed, engine 100 can nonetheless be started with the user experiencing less discomfort, and in addition, better fuel economy can be achieved.

Note that when VVL device 400A is applied, intake valve 118 is lifted in an amount and worked by a working angle that are limited to three levels, and engine 100's operation state can be controlled via a control parameter adapted in a period of time shorter than required when intake valve 118 is lifted in a steplessly varying amount and worked by a steplessly varying working angle. Furthermore, a torque that an actuator requires to vary the amount of lifting intake valve 118 and the working angle on intake valve 118 can be reduced and the actuator can thus be reduced in size and weight. The actuator can thus also be produced at a reduced cost.

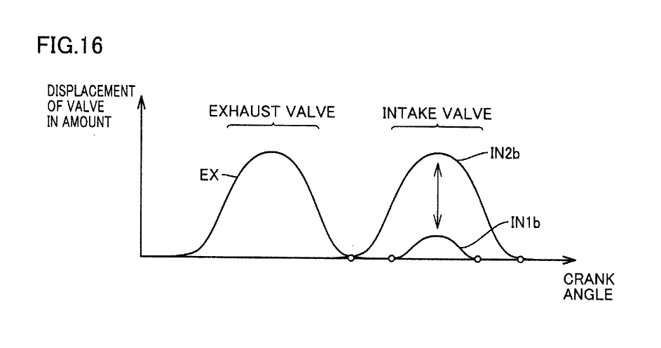

FIG. 16 represents a relationship between the valve's displacement in amount and crank angle, as implemented by a VVL device 400B that can vary intake valve 118's actuation characteristic in two levels. VVL device 400B can vary the actuation characteristic to any one of first and second characteristics. The first characteristic is represented by a waveform IN1b. The second characteristic is represented by a waveform IN2b and corresponds to a larger amount of lift and a larger working angle than the first characteristic.

This case also allows control device 200 to follow the FIG. 15 flowchart to control the intermittent engine operation. More specifically, when the intake valve has the actuation characteristic fixed (YES in S110), control device 200 proceeds to Step S120# to determine whether the intake valve is actuated in a small, fixed amount.

With intake valve 118 having the actuation characteristic (or lifted in an amount and worked by a working angle) switched in two levels by VVL device 400B, if in Step S120# intake valve 118 has the actuation characteristic, or is worked by a working angle and lifted in an amount, fixed to a value corresponding to the first characteristic (IN1a), control device 200 detects that intake valve 118 is actuated in a small, fixed amount (YES in S120#). In contrast, when intake valve 118 has the actuation characteristic, or is worked by a working angle and lifted in an amount, fixed to a value corresponding to the second characteristic (IN2a), control device 200 determines that intake valve 118 is not actuated in a small, fixed amount (NO in S120#).

Consequently, when intake valve 118 having an actuation characteristic (or lifted in an amount and worked by a working angle) switched in two levels by VVL device 400B has the actuation characteristic fixed, engine 100 can nonetheless be started with the user experiencing less discomfort, and in addition, better fuel economy can be achieved.

VVL device 400B allows intake valve 118 to be lifted in an amount and worked by a working angle that are limited to two actuation characteristics, and engine 100's operation state can be controlled via a control parameter adapted in a further shorter period of time. Furthermore, the actuator is allowed to have a simpler configuration. Note that intake valve 118 may not be lifted in an amount or worked by a working angle that are limited to an actuation characteristic varying between two or three levels, and intake valve 118 may be lifted in an amount and worked by a working angle with an actuation characteristic varying between four or more levels.

While the above embodiments and their exemplary variations have been described for a case with the amount of lifting intake valve 118 and the working angle on intake valve 118 both varied as an actuation characteristic thereof, the present invention is also applicable to a configuration with the amount of lifting intake valve 118 alone variable as an actuation characteristic thereof and a configuration with the working angle on intake valve 118 alone variable as an actuation characteristic thereof. A configuration that can vary either the amount of lifting intake valve 118 or the working angle on intake valve 118 can also be as effective as that which can vary both the amount of lifting intake valve 118 and the working angle on intake valve 118. Note that the configuration that can vary either the amount of lifting intake valve 118 or the working angle on intake valve 118 can be implemented via well known technology. Thus, the present invention is applicable to a hybrid vehicle including a variable valve actuation device allowing intake valve 118 to have an actuation characteristic that is represented by an amount of lifting intake valve 118 and/or a working angle on intake valve 118, varying continuously (or steplessly) or discretely (or stepwise).

While the above embodiments have been described in connection with a series/parallel type hybrid vehicle capable of splitting the motive power of engine 100 by power split device 4 and thus transmitting the split motive power to driving wheel 6 and motor generators MG1 and MG2, the present invention is also applicable to hybrid vehicles of other types. More specifically, the present invention is for example also applicable to a so-called series type hybrid vehicle that uses engine 100 only to drive motor generator MG1 and generates vehicular driving force only by motor generator MG2, a hybrid vehicle recovering only regenerated energy of kinetic energy that is generated by engine 100 as electrical energy, a motor-assisted hybrid vehicle using an engine as a main driving force source and assisted by a motor as required, and the like. Furthermore, the present invention is also applicable to a hybrid vehicle which allows a motor to be disconnected and travels by the driving force of the engine alone. In other words, any hybrid vehicle including an internal combustion engine having a variable valve actuation device for varying an actuation characteristic of an intake valve can benefit from the idea of the present invention that when the actuation characteristic, controlled by the variable valve actuation device, is fixed, intermittently stopping the engine is not unconditionally prohibited and is instead permitted depending on the vehicle's status.

Note that, in the above, engine 100 corresponds in the present invention to one embodiment of an internal combustion engine, motor generator MG1 corresponds in the present invention to one embodiment of a rotating electric machine, and VVL devices 400, 400A, 400B correspond in the present invention to one embodiment of a variable valve actuation device.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A hybrid vehicle comprising:
an internal combustion engine having a variable valve actuation device configured to control an actuation characteristic of an intake valve, said actuation characteristic being at least one of an amount of lifting said intake valve and a working angle on said intake valve;
a detector configured to detect said actuation characteristic controlled by said variable valve actuation device;
a rotating electric machine configured to be capable of starting said internal combustion engine;
a power storage device configured to store electric power therein for driving said rotating electric machine; and
a control device configured to receive an output of said detector and also control said internal combustion engine,
said control device permitting intermittently stopping said internal combustion engine, in a case where said detector detects that said actuation characteristic is fixed with said at least one of said amount of lifting said intake valve and said working angle on said intake valve smaller than a prescribed value, when at least one of first to fourth conditions has also been established, said first condition being that said power storage device has an upper limit value for electric power charged having an absolute value larger than a first prescribed electric power value, said second condition being that said power storage device has an upper limit value for electric power discharged having an absolute value larger than a second prescribed electric power value, said third condition being that said power storage device is higher in temperature than a first prescribed temperature, said fourth condition being that the vehicle has a vehicular speed faster than a prescribed speed.

2. The hybrid vehicle according to claim 1, wherein said control device permits intermittently stopping said internal combustion engine, in the case where said actuation characteristic is fixed with said at least one of said amount of lifting said intake valve and said working angle on said intake valve smaller than said prescribed value, when at least any one of said first to fourth conditions, a fifth condition, and a sixth condition has also been established, said fifth condition being that said internal combustion engine has a water coolant higher in temperature than a second prescribed temperature, said sixth condition being that said internal combustion engine has a lubricant oil higher in temperature than a third prescribed temperature.

3. The hybrid vehicle according to claim 1, wherein said control device permits intermittently stopping said internal combustion engine, in the case where said actuation characteristic is fixed with said at least one of said amount of lifting said intake valve and said working angle on said intake valve larger than said prescribed value.

4. The hybrid vehicle according to claim 1, wherein said control device prohibits intermittently stopping said internal combustion engine, in a case where said actuation characteristic is fixed with said at least one of said amount of lifting said intake valve and said working angle on said intake valve smaller than said prescribed value, when none of said first to fourth conditions has been established.

5. The hybrid vehicle according to claim 2, wherein said control device prohibits intermittently stopping said internal combustion engine, in the case where said actuation characteristic is fixed with said at least one of said amount of lifting said intake valve and said working angle on said intake valve smaller than said prescribed value, when none of said first to sixth conditions has been established.

6. The hybrid vehicle according to claim 1, wherein:
said variable valve actuation device is configured to be capable of switching said actuation characteristic of said intake valve to any one of a first characteristic, a second characteristic allowing at least one of said amount of lifting said intake valve and said working angle on said intake valve to be larger than when said actuation characteristic is said first characteristic, and a third characteristic allowing at least one of said amount of lifting said intake valve and said working angle on said intake valve to be larger than when said actuation characteristic is said second characteristic, for a total of three levels; and
said control device permits intermittently stopping said internal combustion engine, in a case where said intake valve has said actuation characteristic fixed in accordance with said first characteristic, when at least any one of said first to fourth conditions has also been established.

7. The hybrid vehicle according to claim 6, wherein said control device permits intermittently stopping said internal combustion engine, in the case where said intake valve has said actuation characteristic fixed in accordance with said first characteristic, when at least any one of said first to fourth conditions, a fifth condition, and a sixth condition has also been established, said fifth condition being that said internal combustion engine has a water coolant higher in temperature than a second prescribed temperature, said sixth condition being that said internal combustion engine has a lubricant oil higher in temperature than a third prescribed temperature.

8. The hybrid vehicle according to claim 6, wherein said control device prohibits intermittently stopping said internal combustion engine, in the case where said intake valve has said actuation characteristic fixed in accordance with said first characteristic, when none of said first to fourth conditions has been established.

9. The hybrid vehicle according to claim 7, wherein said control device prohibits intermittently stopping said internal combustion engine, in the case where said intake valve has said actuation characteristic fixed in accordance with said first characteristic, when none of said first to sixth conditions has been established.

10. The hybrid vehicle according to claim 1, wherein:
said variable valve actuation device is configured to be capable of switching said actuation characteristic of said intake valve to any one of a first characteristic and a second characteristic allowing at least one of said amount of lifting said intake valve and said working angle on said intake valve to be larger than when said actuation characteristic is said first characteristic, for a total of two levels; and
said control device permits intermittently stopping said internal combustion engine, in a case where said intake valve has said actuation characteristic fixed to said first characteristic, when at least any one of said first to fourth conditions has also been established.

11. The hybrid vehicle according to claim 10, wherein said control device permits intermittently stopping said internal combustion engine, in the case where said intake valve has said actuation characteristic fixed in accordance with said first characteristic, when at least any one of said first to fourth conditions, a fifth condition, and a sixth condition has also been established, said fifth condition being that said internal combustion engine has a water coolant higher in temperature than a second prescribed temperature, said sixth condition being that said internal combustion engine has a lubricant oil higher in temperature than a third prescribed temperature.

12. The hybrid vehicle according to claim 10, wherein said control device prohibits intermittently stopping said internal combustion engine, in the case where said intake valve has said actuation characteristic fixed in accordance with said first characteristic, when none of said first to fourth conditions has been established.

13. The hybrid vehicle according to claim 11, wherein said control device prohibits intermittently stopping said internal combustion engine, in the case where said intake valve has said actuation characteristic fixed in accordance with said first characteristic, when none of said first to sixth conditions has been established.

14. The hybrid vehicle according to claim 6, wherein said control device permits intermittently stopping said internal combustion engine, in a case where said actuation characteristic is fixed in accordance with one of said second and third characteristics.

15. The hybrid vehicle according to claim 10, wherein said control device permits intermittently stopping said internal combustion engine, in a case where said actuation characteristic is fixed in accordance with said second characteristic.

16. The hybrid vehicle according to claim 1, wherein said rotating electric machine is mechanically coupled with both an output shaft of said internal combustion engine and a drive shaft of the hybrid vehicle at least via a motive power transmission gear.
